(19) United States
(12) Patent Application Publication
(10) Pub. No.: US 2026/0235161 A1
(43) Pub. Date: Aug. 13, 2026

(54) Torsional Equilibrium Suspension Bushing

(71) Applicant: The Pullman Company LLC, Northville, MI (US)

(72) Inventor: Joseph F. CERRI, III, Norwalk, OH (US)

(21) Appl. No.: 19/050,558

(22) Filed: Feb. 11, 2025

(51) Int. Cl. F16C 33/20

(52) U.S. Cl. CPC F16C 33/205

(57) ABSTRACT

An elastomeric bushing comprises a first bushing subassembly and a second bushing subassembly positioned within an outer tube. A first inner sleeve of the first bushing subassembly includes castellations biasedly engaged with castellations of a second inner sleeve of the second bushing subassembly. The castellations are biasedly engaged with one another in a torsional direction.

### FIELD

The present disclosure relates to an elastomeric bushing for interconnecting a component with a vehicle. More particularly, the present disclosure relates to an elastomeric bushing including a reduced torsional spring rate.

### BACKGROUND

The statements in this section merely provide background information related to the present disclosure and may not constitute prior art.

Over the road vehicles are commonly designed using an independent front and/or an independent rear suspension system to connect the chassis of the vehicle (the unsprung portion) and the body of the vehicle (the sprung portion). The independent suspension systems typically include an upper control arm, a lower control arm and a hub or knuckle which supports the tire of the vehicle. Each control arm is attached to the frame or other structural component of the vehicle using one or more elastomeric bushings. The elastomeric bushings may consist of an outer metal tube which is pressed into the control arm. A layer of elastomer is positioned within the outer metal housing and an inner metal housing which extends through the center of the layer of elastomer. The inner metal housing is attached to a bracket on the frame. The supporting structure or the sprung portion of the vehicle or a bolt extends through the inner metal and secures the end of the control arm to the frame. As the vehicle travels, relative movement between the sprung and unsprung portions of the vehicle is accommodated by flexing of a coil spring, a torsion bar, an air spring or by another resilient device. The flexing of the resilient device causes the ends of the control arms to pivot on the elastomeric bushings which secure the control arms to the sprung portion of the vehicle.

The elastomeric bushings are used to facilitate this pivotal motion and to isolate the vehicle from shock. The layer of elastomer located between the inner and outer metal housings effectively isolates the sprung portion of the vehicle from the unsprung portion of the vehicle. In certain high load applications, the ends of the outer metal are curved or formed over toward the inner metal in order to further encapsulate the layer of elastomeric material. The curving or forming of the ends and thus the further encapsulating of the layer of elastomeric material increases the radial spring rate, increases the axial spring rate, it improves the axial retention and improves the durability of the bushing.

A relatively low torsional parasitic spring rate is a desirable characteristic in elastomer suspension bushings. A low torsional rate allows other suspension components to work more efficiently and reduces overall suspension rate variability. As such, the bushings become a smaller variable in the overall vertical spring rate. Torsional spring rate reduction is currently accomplished via conventional bushing design means including a lower elastomer durometer, increased elastomer rubber wall compression, and a reduced elastomer length.

It may be desirable to provide a bushing having a relatively low torsion rate by internally and permanently balancing torsionally opposed elements. The torsional spring rate presented to the vehicle will be significantly lower than a conventional bushing. The construction presents no special complexity to an end user. All usage and mounting characteristics will stay the same. The unique characteristics are realized by a special assembly method that torsionally articulates two bushing halves (split laterally) in an opposed fashion and utilizes the design characteristics of two individual bushings to lock the two bushing halves together permanently for use.

### SUMMARY

This section provides a general summary of the disclosure, and is not a comprehensive disclosure of its full scope or all of its features.

An elastomeric bushing comprises a first bushing subassembly and a second bushing subassembly positioned within an outer tube. A first inner sleeve of the first bushing subassembly includes castellations biasedly engaged with castellations of a second inner sleeve of the second bushing subassembly. The castellations are biasedly engaged with one another in a torsional direction.

A method of manufacturing an elastomeric bushing comprises aligning castellations of a first inner sleeve of a first bushing subassembly with castellations of a second inner sleeve of a second bushing subassembly, axially translating and press fitting a first outer sleeve of the first bushing subassembly and a second outer sleeve of the second bushing subassembly within an outer tube, engaging the castellations of the first bushing subassembly with the castellations of the second bushing subassembly before completion of the axially translating of the first and second outer sleeves, continuing to axially translate the first and second outer sleeves to elastically deform a first elastomeric bumper of the first bushing subassembly and elastically deform a second elastomeric bumper of the second bushing subassembly to bias the first inner sleeve and the second inner sleeve toward one another, rotating the first inner sleeve and the second inner sleeve relative to each other to torsionally deform the first and second elastomeric bumpers and misalign the castellations, and positioning the first and second inner sleeves relative to one another such that the castellations of the first bushing subassembly interdigitate with and torsionally load against the castellations of the second bushing assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of an exemplary elastomeric bushing constructed in accordance with the teachings of the present disclosure;

FIG. 2 is a cross-sectional side view of the elastomeric bushing depicted in FIG. 1;

FIG. 3 is a cross-sectional view taken through a first bushing subassembly;

FIG. 4 is flow chart describing a method of assembling the elastomeric bushing; and

FIG. 5 is a cross-sectional view taken through a work-in-process version of the elastomeric bushing with elastomeric bumpers shown in the deformed positions.

Corresponding reference numerals indicate corresponding parts throughout the several views of the drawings.

### DETAILED DESCRIPTION

An exemplary embodiment elastomeric bushing will now be described more fully with reference to the accompanying drawings with the elastomeric bushing being identified at reference numeral 10.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

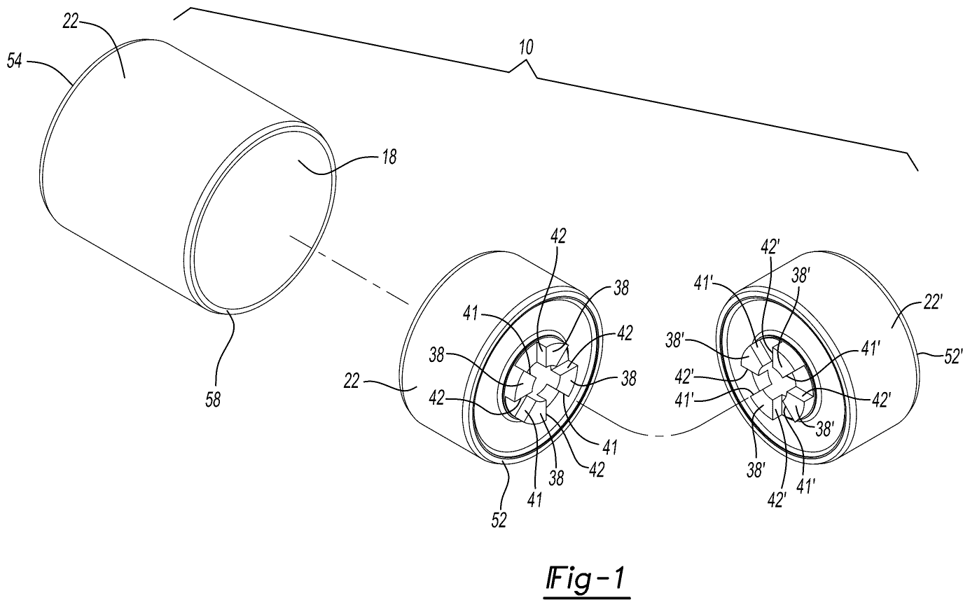

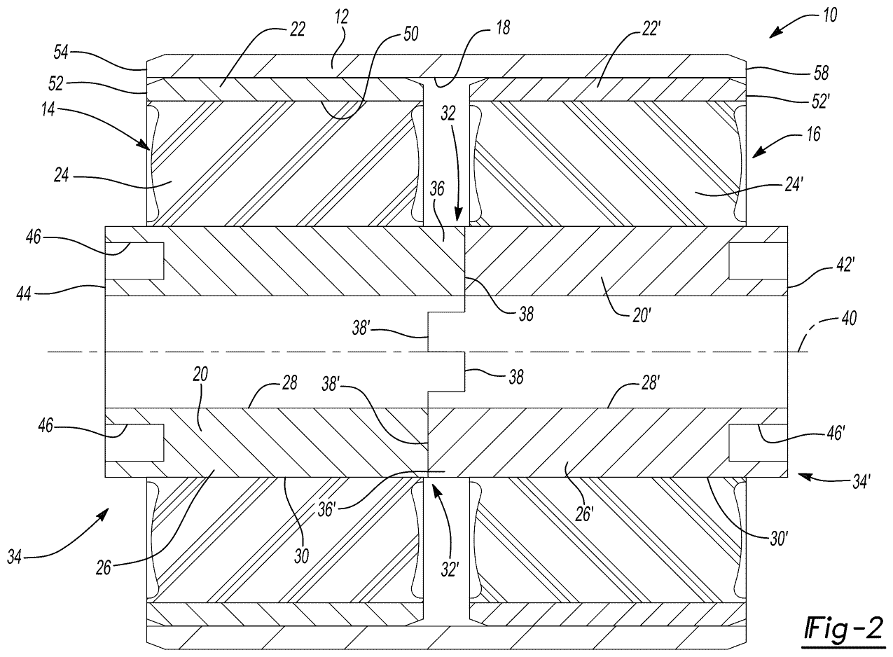

With reference to FIGS. 1-3, elastomeric bushing 10 includes an outer tube 12, a first bushing subassembly 14, and a second bushing subassembly 16. First bushing subassembly 14 may be substantially similar to or identical to second bushing subassembly 16. As such, only first bushing subassembly 14 will be described in detail. FIG. 1 provides an exploded perspective view of elastomeric bushing 10. FIG. 2 depicts elastomeric bushing 10 in a final assembled condition where each of first bushing subassembly 14 and second bushing subassembly 16 are press fit into engagement with an inner surface 18 of outer tube 12.

First bushing subassembly 14 includes an inner sleeve 20, an outer sleeve 22, and an elastomeric bumper 24 positioned radially therebetween. Inner sleeve 20 is a hollow cylindrically shaped member including a wall 26 having an inner cylindrical surface 28 and an outer cylindrical surface 30. It is within the scope of the present disclosure to have a different inner sleeve, including but not limited to, a solid cylindrical component shaped as a bar or a pin. Inner sleeve 20 includes a first end 32 and an opposite second end 34. A plurality of circumferentially spaced apart castellations 36 are integrally formed with wall 26 at first end 32. Each castellation 36 includes a pad 38 shaped as a substantially planar distal surface extending transversely to a longitudinal axis 40 of inner sleeve 20. Each castellation also includes a first side face 41 and a second side face 42 terminating at pad 38. The first and second side faces 41, 42 are angularly spaced from another by less than 45 degrees. Each first side face 41 of one castellation is circumferentially spaced apart from a corresponding second side face 42 of an adjacent castellation by 45 degrees. While these circumferential spacings may be desired, other magnitudes of angular separation are contemplated as being within the scope of the present disclosure.

Wall 26 includes an end face 44 positioned at second end 34. End face 44 may also extend transversely to longitudinal axis 40. A plurality of circumferentially spaced apart bores 46 extend axially inwardly from end face 44. From a manufacturing standpoint, inner sleeves 20, 20′ may be constructed from a mild steel such SAE 1008-1035. Elastomeric bumpers 24, 24′ may be constructed from a natural rubber or other suitable elastomeric material. Outer sleeves 22, 22′ and outer tube 12 may be formed from a mild steel such as SAE 1008, SAE 1010, or SAE 1020.

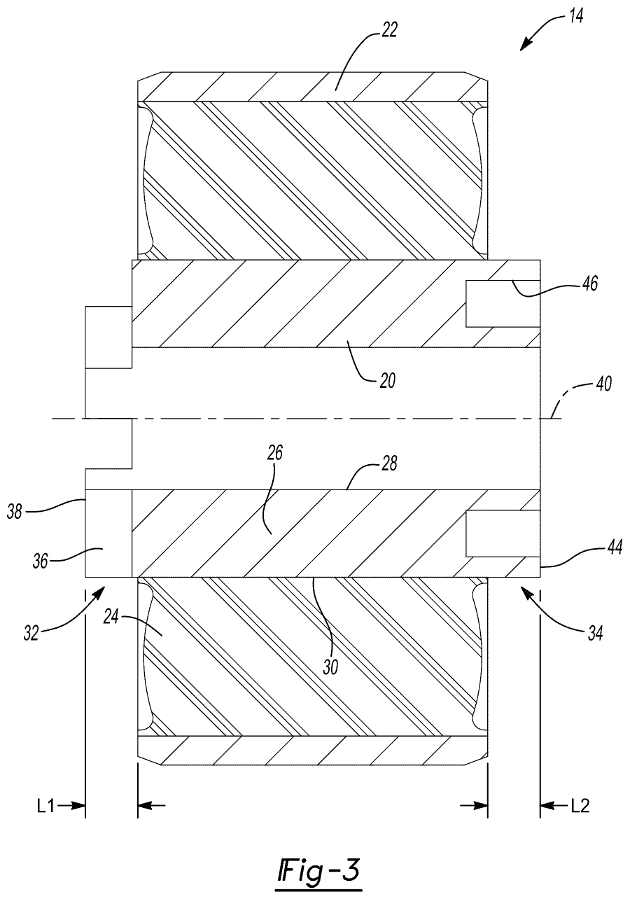

Prior to first bushing subassembly 14 and second bushing subassembly 16 being pressed into outer tube 12 as depicted in FIG. 2, first bushing subassembly 14 is manufactured by injecting a liquid elastomer into a mold containing inner sleeve 20 and outer sleeve 22. At the completion of the injection process, elastomeric bumper 24 is bonded to an inner surface 50 of outer sleeve 22 and outer cylindrical surface 30 of inner sleeve 20 as shown in FIG. 3. At the completion of molding, the relative axial positions of outer sleeve 22, inner sleeve 20 and elastomeric bumper 24 are substantially same as the positions depicted in FIG. 2 and FIG. 3. More particularly, inner sleeve 20 and elastomeric bumper 24 are substantially symmetrically centered with outer sleeve 22. An equal amount of inner sleeve 20 may extend beyond the axial extent of outer sleeve 22 on each side as identified by a first length L1 and a second length L2. It should be appreciated that alternate embodiment first and second bushing assemblies are contemplated that are not symmetrically arranged as previously described.

As noted, second bushing subassembly 16 is substantially similar to first bushing subassembly 14. For clarity, like elements will not be discussed in detail but such elements will be identified with similar reference numerals including a prime suffix. The construction method of second bushing subassembly 16 is substantially the same as previously described in relation to first bushing subassembly 14.

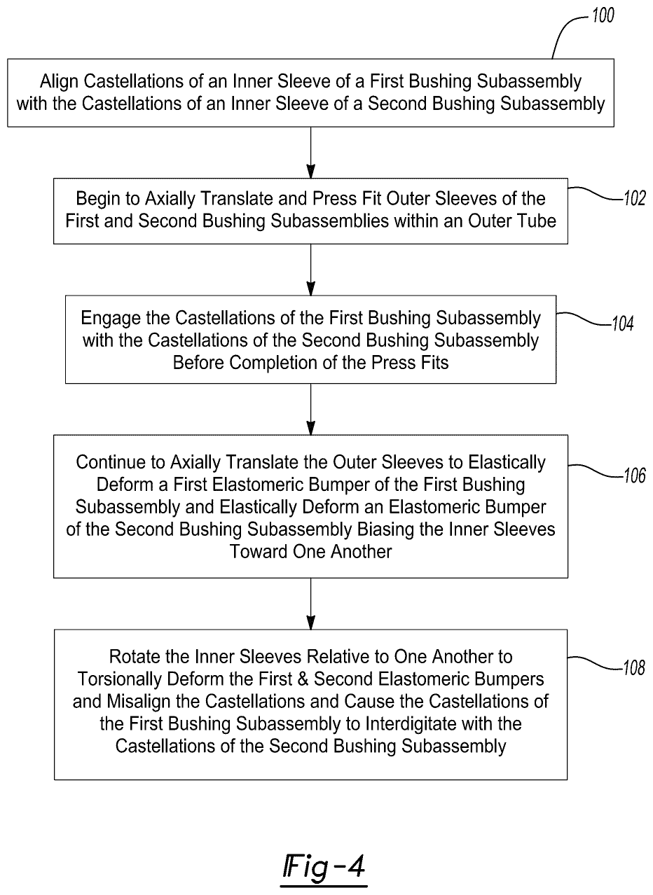

A method of assembling elastomeric bushing 10 is shown in FIG. 4 and includes rotationally aligning castellations 36 of first bushing subassembly 14 with castellations 36′ of second bushing subassembly 16 at step 100. Pads 38 are aligned with pads 38′. At step 102, first bushing subassembly 14 and second bushing subassembly 16 are axially translated toward one another. Outer sleeve 22 is engaged in a press-fit interconnection with outer tube 12. Outer sleeve 22 is axially translated into outer tube 12 until an end face 52 of outer sleeve 22 is aligned with and substantially coplanar with a first end face 54 of outer tube 12. In similar fashion, second bushing subassembly 16 is axially translated within outer tube 12 in a press-fit arrangement until end face 52′ of outer sleeve 22′ is aligned with and substantially coplanar with a second end face 58 of outer tube 12.

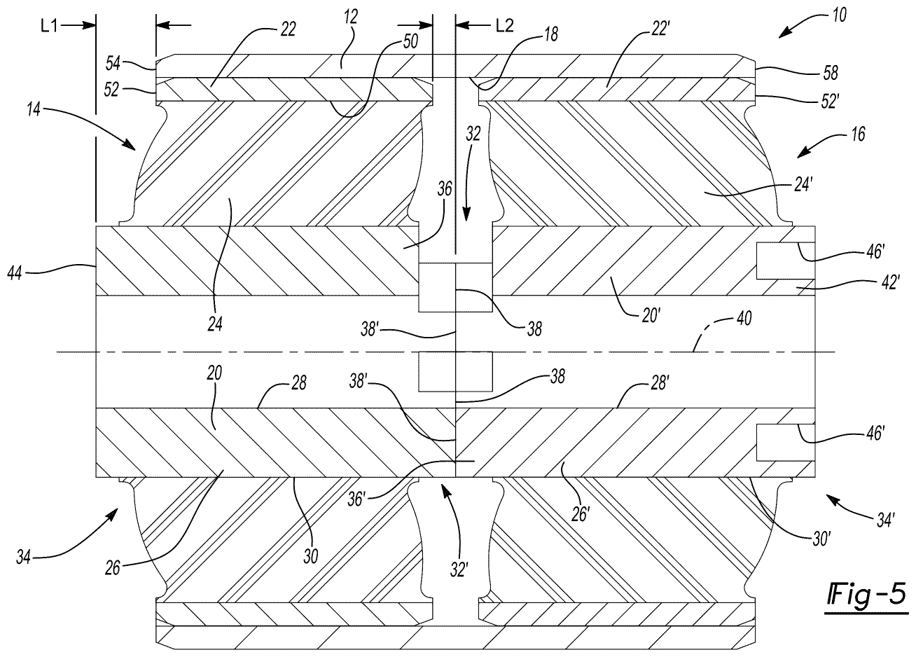

It is important to note that prior to completing the axial translations associated with the press fitting steps, pads 38 engage pads 38′ as noted at step 104. FIG. 5 depicts a work-in-process assembly condition of elastomeric bushing 10 at the completion of step 106. Because pads 38 and pads 38′ engage one another prior to outer sleeves 22, 22′ being in their final installed position, elastomeric bumpers 24, 24′ deform as pictorially represented in FIG. 5. Based on the elastomeric properties of the elastomeric bumpers 24, 24′, relative axial movement between inner sleeve 20 and outer sleeve 22 as well as between inner sleeve 20′ and outer sleeve 22′ occurs. At the work-in-process position depicted in FIG. 5, an axial load is generated by each of elastomeric bumpers 24, 24′ to axially bias inner sleeve 20 into engagement with inner sleeve 20′.

At process step 108 subsequent to the work-in-process condition depicted in FIG. 5, axially extending prongs of a tool (not shown) are positioned within bores 46 of inner sleeve 20 and bores 46′ of inner sleeve 20′. Inner sleeve 20 is rotated relative to inner sleeve 20′ a sufficient rotational amount to cause pads 38 to no longer be aligned with pads 38′. In the embodiment shown in the figures, each inner sleeve 20, 20′ is rotated 22.5 degrees in opposite directions to misalign the pads 38, 38′. Once the pads 38, 38′ are no longer aligned with one another, the axial biasing force previously described urging inner sleeve 20 toward inner sleeve 20‘causes relative axial translation of inner sleeve 20 toward second bushing subassembly 16. Similarly, stored energy within elastomeric bumper 24’ urges inner sleeve 20′ toward first bushing subassembly 14. Once the relative rotation amount is sufficient to no longer align the pads of castellations 36 with the pads of castellations 36′, the castellations become interdigitated as depicted in FIG. 2. The axial loads previously described are relieved. Depending on the magnitude of the axial loads, the inner sleeves 20, 20′ may “snap” into their positions depicted in FIG. 2 from the work-in-process positions shown in FIG. 5.

Interestingly, the process steps previously described induce and then subsequently release the axial loads urging inner sleeves 20, 20′ toward one another. The process step 108 of rotating inner sleeve 20 relative to outer sleeve 22 and rotating inner sleeve 20′ relative to outer sleeve 22′ in the opposite direction imparts a torsional load on each of inner sleeves 20, 20′. Once the castellations 36, 36′ are interdigitated, a torsional load remains urging first set of side faces 41 formed on castellations 36 into biased engagement with second set of side faces 42′ formed on castellations 36′. The result of the assembly process provides internally and permanently balancing torsionally opposed elements. The torsional spring rate presented to the vehicle will be significantly lower than a conventional bushing.

It should also be noted that pads 38 are axially spaced apart from pads 38 ′ when elastomeric bushing 10 is in the final assembled condition shown in FIG. 2. Pads 38 may be spaced apart from all portions of inner sleeve 20 or alternatively may be engaged with wall 26′ with a force significantly less than the biasing force associated with the work-in-process position depicted in FIG. 5. Similarly, pads 38′ may be entirely spaced apart from inner sleeve 20, positioned adjacent thereto, or in contact with inner sleeve 20 at a light load.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. Modifications and variations of the present disclosure are possible in light of the above teachings and may be practiced otherwise than as specifically described while within the scope of the appended claims.

What is claimed is:

1. An elastomeric bushing comprising:
an outer tube;
a first bushing subassembly positioned within the outer tube and including a first inner sleeve, a first elastomeric bumper disposed around and directly engaging the first inner sleeve, and a first outer sleeve disposed around the first inner sleeve and the first elastomeric bumper; and
a second bushing subassembly positioned within the outer tube and including a second inner sleeve, a second elastomeric bumper disposed around and directly engaging the second inner sleeve, and a second outer sleeve disposed around the second inner sleeve and the second elastomeric bumper, wherein the first inner sleeve and the second inner sleeve each include circumferentially spaced apart castellations biasedly engaged with one another in a torsional direction.

2. The elastomeric bushing according to claim 1, wherein the first inner sleeve is a hollow cylindrically-shaped one-piece monolithic component including the castellations.

3. The elastomeric bushing according to claim 1, wherein the first elastomeric bumper is bonded to the first inner sleeve.

4. The elastomeric bushing according to claim 1, wherein the first elastomeric bumper is bonded to the first outer sleeve.

5. The elastomeric bushing according to claim 1, wherein the first inner sleeve is coaxially aligned with the first outer sleeve.

6. The elastomeric bushing according to claim 1, wherein the first inner sleeve is coaxially aligned with the second inner sleeve.

7. The elastomeric bushing according to claim 1, wherein the first inner sleeve axially extends beyond the first outer sleeve at each end of the first outer sleeve.

8. The elastomeric bushing according to claim 1, wherein the first outer sleeve and the second outer sleeve are press fit within the outer tube.

9. The elastomeric bushing according to claim 1, wherein the first elastomeric bumper is in a deformed position when castellations of the first inner sleeve and the second inner sleeve are biasedly engaged with one another in torsion.

10. A method of manufacturing an elastomeric bushing, comprising:
aligning castellations of a first inner sleeve of a first bushing subassembly with castellations of a second inner sleeve of a second bushing subassembly;
axially translating and press fitting a first outer sleeve of the first bushing subassembly and a second outer sleeve of the second bushing subassembly within an outer tube;
engaging the castellations of the first bushing subassembly with the castellations of the second bushing subassembly before completion of the axially translating of the first and second outer sleeves;
continuing to axially translate the first and second outer sleeves to elastically deform a first elastomeric bumper of the first bushing subassembly and elastically deform a second elastomeric bumper of the second bushing subassembly to bias the first inner sleeve and the second inner sleeve toward one another;
rotating the first inner sleeve and the second inner sleeve relative to each other to torsionally deform the first and second elastomeric bumpers and misalign the castellations; and
positioning the first and second inner sleeves relative to one another such that the castellations of the first bushing subassembly interdigitate with and torsionally load against the castellations of the second bushing assembly.

11. The method of claim 10, further comprising bonding the first elastomeric bumper to the first inner sleeve.

12. The method of claim 11, further comprising bonding the first elastomeric bumper to the first outer sleeve.

13. The method of claim 10, wherein the first inner sleeve is a hollow cylindrically-shaped one-piece monolithic component including the castellations.

14. The method of claim 10, further comprising coaxially aligning the first inner sleeve with the first outer sleeve.

15. The method of claim 10, further comprising coaxially aligning the first inner sleeve with the second inner sleeve.

16. The method of claim 10, further comprising axially extending the first inner sleeve beyond the first outer sleeve at each end of the first outer sleeve.

17. The method of claim 10, further comprising press fitting the first outer sleeve and the second outer sleeve within the outer tube.
